(19) United States
(12) Patent Application Publication
(10) Pub. No.: US 2023/0352844 A1
(43) Pub. Date: Nov. 2, 2023

(54) Horn antenna

(71) Applicant: THALES, COURBEVOIE (FR)

(72) Inventors: Stéphane MALLEGOL, BREST (FR); Yoann HENAFF, BREST (FR)

(21) Appl. No.: 18/303,961

(22) Filed: Apr. 20, 2023

(30) Foreign Application Priority Data
Apr. 27, 2022 (FR) 2203946

(51) Int. Cl. H01Q 13/02; H01Q 1/48; H01Q 1/52; H01Q 1/42

(52) U.S. Cl. CPC H01Q 13/02; H01Q 1/48; H01Q 1/52; H01Q 1/42

(57) ABSTRACT

A horn antenna including a ground plane delimiting an upper half-space, a horn forming one end of a waveguide, the horn crossing through the ground plane so that a mouth of the horn is arranged at a predetermined height above the ground plane in the upper half-space. The antenna is characterized in that it includes at least one resistive film arranged around the horn, parallel to an upper face of the ground plane, the resistive film having an electrical resistance suitable for limiting creeping waves.

### REFERENCE TO RELATED APPLICATION

This application is a U.S. non-provisional application claiming the benefit of French Application No. 22 03946, filed on Apr. 27, 2022, the contents of which are incorporated herein by reference in their entirety.

### TECHNICAL FIELD OF THE INVENTION

The field of the invention is that of horn antennas with a wide frequency band.

### BACKGROUND OF THE INVENTION

When the working frequency is beyond 18 GHz (i.e., beyond the Ku band), the dimensions of the horn are reduced, making such a solution compatible with integration constraints on carrier structures.

As a result, horn antennas are now used in signal intelligence or electronic countermeasure applications. A horn antenna can thus be used alone as a high-gain antenna or as an elementary antenna of a high-gain, directional beam antenna array for transmitting or receiving systems. A horn antenna can also be used as an elementary antenna of a planar array antenna for application in amplitude goniometry. Finally, a horn antenna can be used as an elementary antenna of a multi-plane antenna array for application in phase goniometry/interferometry.

As shown in FIG. 1, a horn antenna includes a waveguide the flared end of which, forming the horn of the antenna, crosses through a ground plane so as to open above the latter in order to transmit and/or receive a main radiation A in the upper half-space situated above the ground plane.

However, when a horn is positioned close to a ground plane (more generally a metal plane), creeping waves B are generated at the upper face of the ground plane and propagate away radially from the horn at the surface of the ground plane.

The creeping waves can be amplified C by physical and/or electromagnetic discontinuities, in particular at the edge of the ground plane. The creeping waves can then combine with the main radiation A, which results in an alteration of the radiation pattern of the horn antenna evolved in the far field. In particular, the radiation pattern exhibits pronounced oscillations of the main lobe thereof (as represented in the curves CE1 and CH1 of the graphs shown in FIG. 5). The above is a serious alteration of the radiation pattern, which can lead to detection errors. It should be emphasized that deterioration of the radiation pattern is all the more pronounced as the working frequency is high.

The creeping waves are also amplified by presence of a radome, the presence of which is made necessary for covering the horn of the antenna and for preventing aggressions from the external environment. More precisely, depending on the thickness thereof and the real part of the relative permittivity of the material composing same, the radome enhances the creeping waves. The radome can also modify the period of the waves, for a given frequency and/or a given angular domain.

In order to attenuate the creeping waves and negative effects thereof, it is known how to move the mouth of the horn away from the ground plane. However, such solution is insufficient, especially since it is sought to make horn antennas of small thickness. It is thus not possible to greatly increase the height by which the horn protrudes above the ground plane. Moreover, by moving the ground plane away from the mouth of the horn, the antenna loses efficiency since energy radiated by the horn is no longer constrained in the half-space in front of the horn.

Another solution consists of producing corrugations on the upper face of the ground plane in order to trap the creeping waves.

Such corrugations have a depth of λ/4 and a pitch between two successive corrugations less than or equal to λ/2 (λ being the wavelength associated with the central frequency of the range of the working frequency of the horn antenna considered). The corrugations behave like resonators apt to absorb surface waves.

While such solution has the advantage of enabling efficient trapping of creeping waves at the center frequency, the solution has many drawbacks: the working frequency range is reduced, since the absorption effect is optimized for the center frequency and the efficiency of the resonators is reduced as soon as one deviates too much from the center frequency (relative passband between 15% and 20%); strong constraints of production, since thickness of the ground plane has to be greater than depth of the corrugations, the number of corrugations has to be sufficient to absorb surface waves efficiently, machining precision of the corrugations has to be high so as to avoid affecting response of the antenna at high working frequencies, and thinning of the ground plane raises problems of mechanical strength.

Another solution of the prior art consists of integrating, into the radome of the horn antenna, a frequency selective surface (FSS). An FSS surface is a layer made by arranging metallic elements in a periodic pattern.

The radome is composed, e.g., of a dielectric material. On a lower face (facing the horn and the ground plane), the radome has a first FSS surface and a second FSS surface on the upper face thereof.

However, such a solution does not have as the primary goal thereof to trap creeping waves, but rather to minimize radar cross-section (RCS).

Moreover, such solution has the following drawbacks: loss of radiation efficiency, since the FSSs in line with the horn antenna absorb part of the radiated energy; limited passband, since the metallic elements forming the FSSs are dimensioned to be effective at the center frequency and the resonant effect on which the operation of an FSS is based strongly decreases when deviating from the center frequency (relative passband around 10%); complexity of producing such a radome; need to protect the composite radome by an additional radome covering the second FSS exposed to aggressions; need for a minimum distance between the radome and the mouth of the horn for the FSSs to be effective, which increases thickness of the horn antenna produced.

Finally, another solution of the prior art consists of producing a high impedance surface (HIS) around the mouth of the horn of the antenna on the upper face of the ground plane.

A HIS is composed of metallic elements arranged periodically and connected to the ground plane by a metallized via.

Such a solution has the advantage of being compatible with conventional printed circuit manufacturing technologies.

However, the solution has the drawback of once again leading to a limited working frequency band because of dimensioning of the metal elements, which constrains the range wherein the surface indeed absorbs creeping waves (electromagnetic band gap less than 20%).

Thereby, none of the known solutions can be used for producing a compact horn antenna (i.e., having a small thickness), having a wide working frequency range, while limiting effects of creeping waves on radiation performance.

### SUMMARY OF THE INVENTION

Thus, the goal of the present invention is to propose a solution to all or some of such problems.

For this purpose, the subject matter of the invention is a horn antenna including a ground plane, delimiting an upper half-space, a horn forming one end of a waveguide, the horn crossing through the ground plane so that a mouth of the horn is arranged at a predetermined height above the ground plane in the upper half-space, characterized in that the horn antenna includes at least one resistive film arranged around the horn, parallel to an upper face of the ground plane, the resistive film having an electrical resistance which limits creeping waves.

According to particular embodiments, the horn antenna includes one or more of the following features, taken individually or according to all technically possible combinations:
the resistive film is supported by the ground plane;
the antenna further includes at least one support layer suitable for supporting the resistive film, the support layer being arranged around the horn, parallel to the upper face of the ground plane;
the support layer is made of a material apt to attenuate creeping waves;
the support layer results from assembly of a plurality of elementary layers;
the antenna includes a first resistive film supported by an upper surface of the support layer, and a second resistive film supported by a lower surface of the support layer;
the horn antenna has a radome covering the mouth of the horn;
the resistive film is supported by a lower face of the radome, oriented towards the ground plane;
the radome has an outer contour wherein the resistive film extends to the vicinity of the outer contour of the radome;
the ground plane has a peripheral edge raised so as to receive the radome, the peripheral edge of the ground plane coinciding with the outer contour of the radome;
the resistive film has one or a plurality of solid angular sectors;
the resistive film has one or a plurality of concentric ring arcs;
the resistive film has at least two concentric rings having different electrical resistances;
the resistive film is made of a material compatible with manufacturing by screen printing; and
the antenna is apt to operate over a wide range of working frequencies above the X-band.

### BRIEF DESCRIPTION OF THE DRAWINGS

The invention and the advantages of the invention will be better understood upon reading the detailed description of the different embodiments of the invention, given only as examples and not limited to, the description being made with reference to the enclosed drawings, wherein:

FIG. 1 is a schematic axial sectional view of horn antenna according to the prior art;

FIG. 2 is a perspective exploded view of a preferred embodiment of a horn antenna according to the invention;

FIG. 3 is a schematic longitudinal sectional view along an axial plane of the horn antenna shown in FIG. 2;

FIG. 4 shows different variants of embodiments of the resistive film of the antenna, as shown in FIG. 2; and

FIG. 5 shows the gains of a horn antenna of the prior art and a horn antenna according to the invention, in the plane E and in the plane H.

### DETAILED DESCRIPTION OF EMBODIMENTS

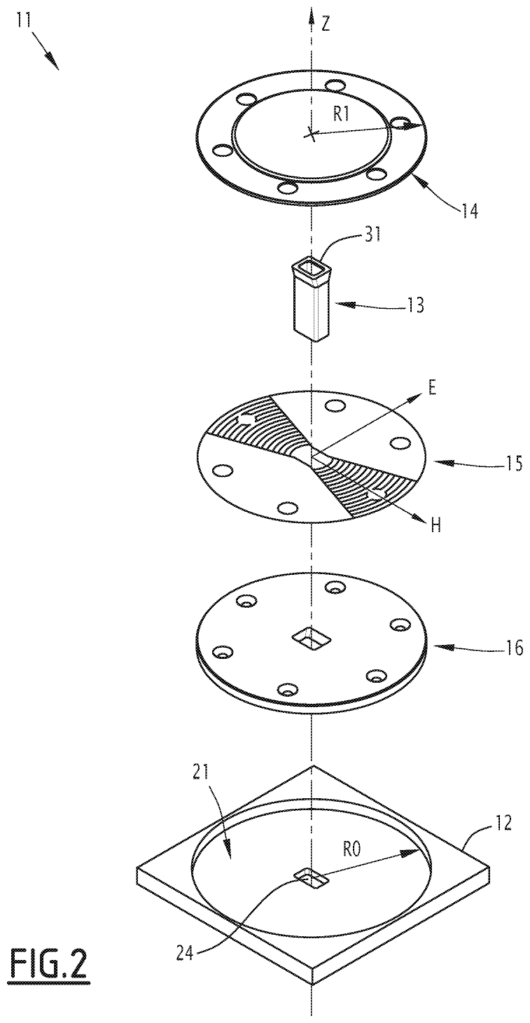

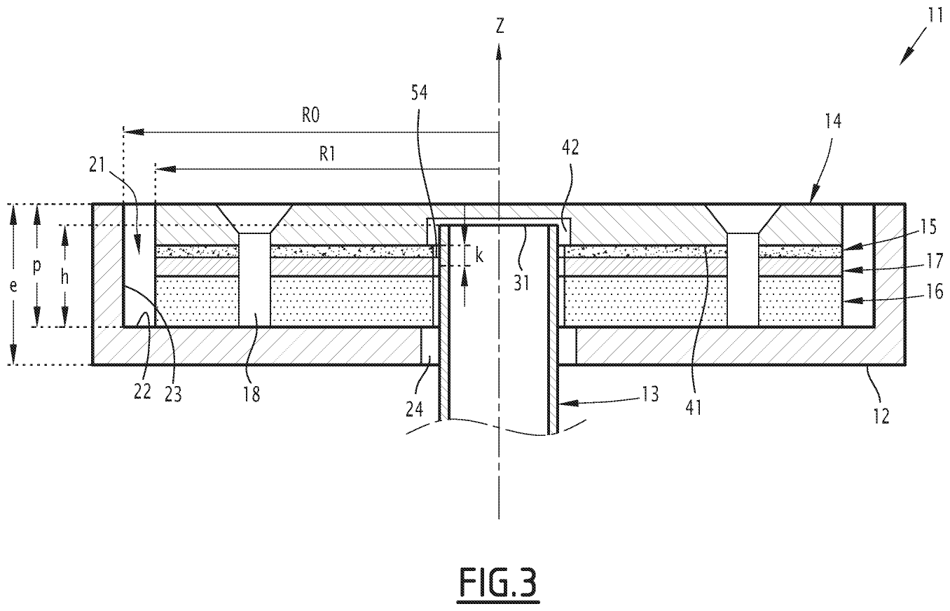

With reference to FIGS. 2 and 3, a preferred embodiment of the horn antenna according to the invention will be presented.

A horn antenna 11 includes a ground plane 12 and a horn 13 along a so-called vertical axis Z.

Ground plane 12 has, e.g., a rectangular parallelepiped external shape, with a square base and of reduced thickness, e. In a variant, the ground plane has a cylindrical shape.

Ground plane 12 has a central recess 21 of cylindrical shape, of radius R0 and of depth p. Recess 21 has a bottom 22 and a peripheral edge 23. Bottom 22 is the upper face of ground plane 12 where creeping waves develop.

Ground plane 12 is provided with a central opening 24 letting through horn 13.

Horn 13 has, e.g., a constant cross-section (i.e., in a plane orthogonal to axis Z), e.g., with a rectangular shape. In a variant, the section of the horn may have other shapes, e.g., flared and/or circular.

Horn 13 is arranged in such a way that a mouth 31 thereof is placed above bottom 22 of recess 21 of ground plane 12, at a height h above ground plane 12.

Horn antenna 11 includes a radome 14 closing recess 21 of ground plane 12 and covering mouth 31 of horn 13.

Radome 14 has essentially the form of a disk with radius R1, smaller than R0.

A lower face 41 of radome 14, oriented towards bottom 22 of ground plane 12, is advantageously provided with a central housing 42, shaped so as to receive mouth 31 of horn 13.

According to the invention, horn antenna 11 incorporates at least one resistive film 15.

Resistive film 15 is arranged so as to surround horn 13 and be received in recess 21 of ground plane 12.

In the present embodiment, resistive film 15 is arranged in a transverse plane. Resistive film 15 is inscribed in a disk of radius R1.

Resistive film 15 is thin. Resistive film 15 has a thickness, k, typically between 10 μm and 20 μm. Such a thickness makes integration possible without increasing total thickness, e, of horn antenna 11.

Resistive film 15 has a central opening 54, the cross-section of which preferably corresponds to the thickness of horn 13, so that resistive film 15 is positioned as close as possible to horn 13 (along a transverse plane), in order to maximize effectiveness thereof in reducing creeping waves.

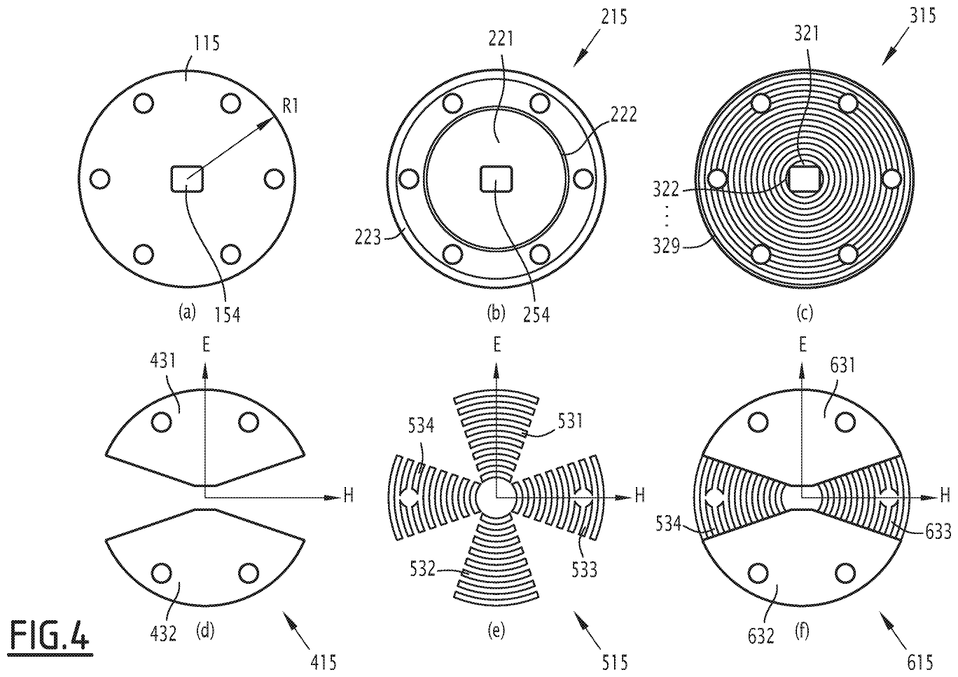

Different variant embodiments of the resistive film are presented hereinafter in relation to FIG. 4.

In the embodiment shown in FIGS. 2 and 3, horn antenna 11 advantageously includes a support layer 16 suitable for supporting resistive film 15.

In the present embodiment, layer 16 is arranged in a transverse plane. Layer 16 is inscribed in a disk of radius R1.

Layer 16 has a thickness enabling resistive film 15 to be positioned slightly set back from mouth 31 of horn 13 along the vertical direction. Layer 16 also fills recess 21 of ground plane 12.

The material of layer 16 is preferentially a dielectric or (magneto)dielectric material. The material has a low dielectric constant, typically less than or equal to 2. The material is a low-loss material. The choice of such a material contributes to attenuation of creeping waves, in particular by not enhancing propagation of creeping waves at lower face 41 of radome 14.

In the present embodiment, resistive film 15 is bonded over layer 16. The adhesive layer is referenced by number 17 in FIG. 3. Adhesive layer 17 has a thickness preferably between 50 μm and 250 μm. Adhesive layer 17 is actually thicker than resistive film 15. Adhesive layer 17 is not shown in FIG. 2.

Radome 14 and the assembly consisting of resistive film 15 and of layer 16 are held in position on ground plane 12 by a series of screws, one of which is shown in FIG. 3 and has reference 18. Possibly tapped holes are provided in components of horn antenna 11 so as to receive the screws.

### Other Embodiments

Other embodiments are conceivable.

In particular, the radome, the central recess, the resistive film, and the support layer may have a rectangular parallelepiped shape.

The resistive film may, e.g., be directly supported on the upper face of ground plane 12. The film, e.g., is bonded on the upper face.

The resistive film may, e.g., be directly supported on lower face 41 of radome 14. The resistive film, e.g., is bonded on the lower face.

Other ways of attaching the resistive film onto a support layer, the ground plane or the radome are known to the person skilled in the art, and attachment by bonding is only an example particularly easy to implement.

A plurality of resistive films may, e.g., be provided, arranged vertically one on top of the other. Two successive resistive films are advantageously separated by an intermediate layer similar to support layer 16, but the thickness of which is reduced so that the laminate thereby produced does not have a negative impact on the total thickness of the horn antenna.

A layer, such as support layer 16, may be produced by overlaying a plurality of elementary layers.

If appropriate, the horn antenna may be non-planar. In such case, the or each resistive film (and, where appropriate, each support layer) are shaped so as to follow the curvature of the ground plane.

Instead of bonding, other ways of attaching the resistive film (onto the ground plane, the support layer and/or the radome) are possible.

### Variant Embodiments of the Resistive Film

FIG. 4 illustrates different embodiments of the resistive film.

In a first variant of embodiment (a), resistive film 115 is solid. Resistive film 115 forms a circular continuous surface of radius R1 with a central opening 154 matching the outer contour of the horn. A resistive film is made of one material having only one resistive value, e.g., between 100 and 10,000 Ω/sq.

In order to have additional degrees of freedom for adapting radio frequency performance of the horn antenna, the resistive film may have other configurations.

Thereby, in a second variant (b), a resistive film 215 results from combination of two materials with different resistive values. The first material forms a disk 221 with a central opening 254 and a plurality of concentric annular grooves 222 and 223. The second material fills the grooves. The radius of a groove, the depth thereof and/or the thickness thereof may be varied so as to adapt properties of the antenna. It is possible to opt for more than two materials with different resistive values. Instead of annular grooves, polygonal grooves may be provided.

In a third variant (c), a resistive film 315 consists of association of a plurality of concentric rings, 321-329, the outer radius of one ring corresponding to the inner radius of the next ring and the material of each ring being chosen for generating a radial resistive gradient with a minimum resistive value at the center, and a maximum resistive value at the periphery. In this way, the impact of a high resistive value in the vicinity of the radiating mouth of the horn is limited, in particular on the flanks of the radiation pattern in plane E. Moreover, in this way it is possible to provide optimum attenuation of creeping waves in the vicinity of the edge of the structure and, thereby, to limit associated edge effects.

In a fourth variant (d), a resistive film 415 does not form a continuous surface, but a partial surface. Resistive film 415 does not completely cover the transverse plane around the mouth of the horn. In FIG. 4, resistive film 415 is, e.g., composed of a plurality of solid angular sectors, in the present case two solid angular sectors 431 and 432 along plane E. The two solid angular sectors 431 and 432 are thus non-contiguous. The flare of the angular sectors may be adjusted for setting the properties of the horn antenna. More precisely, such a configuration has the advantage of not degrading radiation efficiency of the horn antenna (at the radiating mouthpiece) while providing efficiency in trapping creeping waves over a frequency wide-bandgap. The effect of the latter on the radiation pattern ripples in plane E is then minimized.

In a fifth variant of embodiment (e), a resistive film 515 does not form a continuous surface, but a partial surface. Resistive film 515 does not completely cover the transverse plane around the mouth of the horn. In FIG. 4, resistive film 515 is, e.g., composed of a plurality of perforated angular sectors, in the present case two perforated angular sectors 531 and 532 along plane E and two perforated angular sectors 533 and 534 along plane H, the perforated angular sectors being non-contiguous. An apertured angular sector consists, e.g., of one or a plurality of concentric arcs of a ring. The flare of the angular sectors may be adjusted for setting properties of the horn antenna, and geometry of the ring arcs (spacing, thickness, material used, etc.) may also be adjusted.

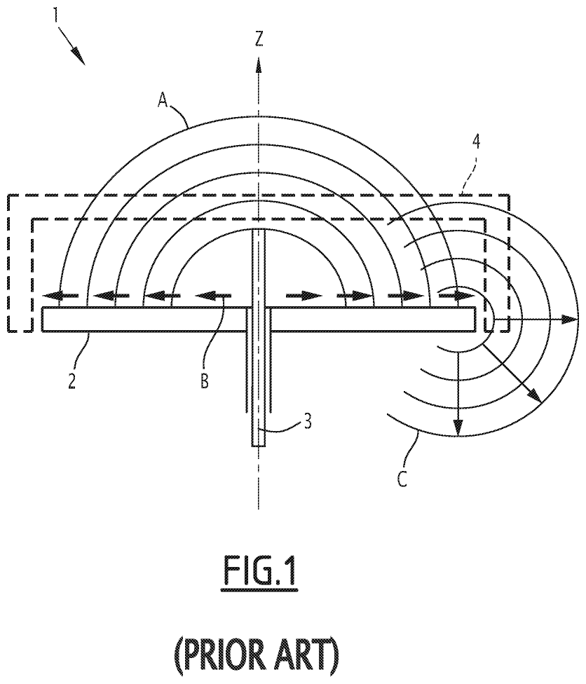

Finally, in a sixth variant (f), a resistive film 615 results from combination of variants (d) and (e) with two solid angular sectors 631 and 632 along plane E and two perforated angular sectors 633 and 634 along plane H. In such a variant, addition of resistive ring arcs forming the junction between the continuous angular sectors, enhances trapping of creeping waves and reduction of edge effects of the structure, in particular along plane H. The width of the resistive addition is preferentially chosen to be less than or equal to λ/4 (with λ the wavelength chosen, usually, at the central operating frequency). The sixth variant is preferable because it has the advantages of the fifth variant (e) while keeping advantages of the solid solution in plane E (fourth variant (d)). It is this sixth variant which has been chosen for the embodiment shown in FIGS. 1 and 2.

It should be noted that resistive films may be optimized by electromagnetic simulation.

A resistive film may advantageously be produced by using a conventional screen-printing method. In a variant, it may be produced by an equivalent process: aerosol printing, 3D printing, etc.

The resistive film is, e.g., made with a carbon-enriched polymer ink, a material suitable for screen printing manufacturing. Alternatively, the resistive film is a carbon-enriched thermoplastic, e.g., an ESD (Electrostatic Discharge) thermoplastic, a material suitable for production by 3D printing.

### Results

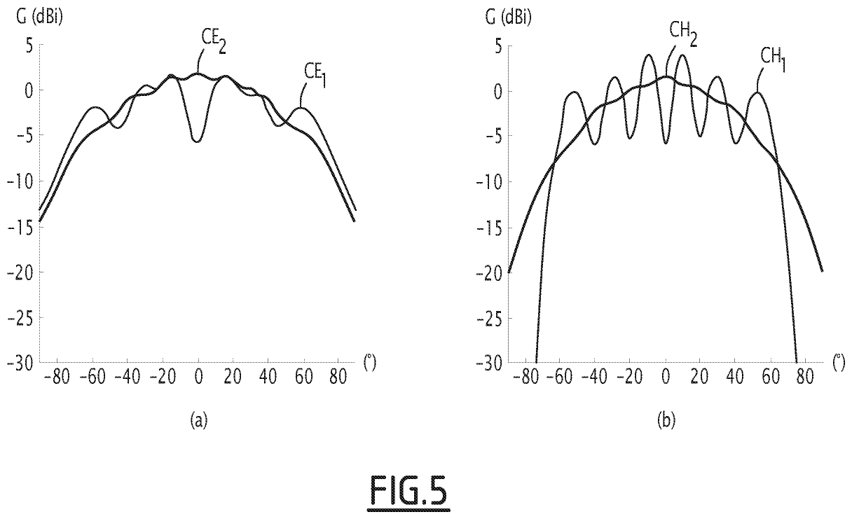

FIG. 5 highlights the positive impact of the inclusion of a solid thin resistive film on the gain of a horn antenna compared to a horn antenna of the prior art. In graph (a) on the left of FIG. 5, the gain is evaluated in plane E, and in graph (b) on the right of FIG. 5, the gain is evaluated in plane H. The gains are given herein for a frequency of 25 GHz.

In general, with the invention, it was found, in particular:
stabilization of the frequency dependence of the gain along the radio axis;
at a given frequency, clear reduction of gain ripples in the main lobe of the radiation pattern;
stabilization of the angular aperture of the main lobe of the radiation pattern; and,
control of the rise of the secondary lobes of the radiation pattern.

1. A horn antenna comprising:
a ground plane, delimiting an upper half-space;
a horn, forming one end of a waveguide, the horn crossing through said ground plane so that a mouth of the horn is arranged at a predefined height above said ground plane in the upper half-space; and
at least one resistive film, arranged around said horn, parallel to an upper face of said ground plane, the at least one resistive film having an electrical resistance suitable for limiting creeping waves.

2. The horn antenna according to claim 1, wherein said at least one resistive film is supported by said ground plane.

3. The horn antenna according to claim 1, further comprising at least one support layer suitable for supporting said at least one resistive film, the support layer being arranged around said horn, parallel to the upper face of said ground plane.

4. The horn antenna according to claim 3, wherein said support layer is comprised of a material apt to attenuate creeping waves.

5. The horn antenna according to claim 3, wherein said support layer results from assembly of a plurality of elementary layers.

6. The horn antenna according to claim 3, comprising:
a first resistive film supported by an upper surface of said support layer; and
a second resistive film supported by a lower surface of said support layer.

7. The horn antenna according to claim 3, comprising a radome covering the mouth of said horn.

8. The horn antenna according to claim 7, wherein said at least one resistive film is supported by a lower face of said radome, oriented towards said ground plane.

9. The horn antenna according to claim 7, wherein said radome has an outer contour and wherein said at least one resistive film extends to the vicinity of the outer contour of said radome.

10. The horn antenna according to claim 9, wherein said ground plane has a raised peripheral edge for receiving said radome, the peripheral edge of said ground plane coinciding with the outer contour of said radome.

11. The horn antenna according to claim 1, wherein said at least one resistive film includes one or a plurality of solid angular sectors.

12. The horn antenna according to claim 1, wherein said at least one resistive film includes one or a plurality of concentric ring arcs.

13. The horn antenna according to claim 1, wherein said at least one resistive film includes at least two concentric rings with different electrical resistances.

14. The horn antenna according to claim 1, wherein said at least one resistive film is made of a material compatible with manufacturing by screen printing.

15. The horn antenna according to claim 1, suitable for operating over a wide range of working frequencies above the X-band.
